(19) United States
(12) Patent Application Publication
(10) Pub. No.: US 2002/0049783 A1
(43) Pub. Date: Apr. 25, 2002

(54) Interactive multimedia content builder

(76) Inventors: Steven N. Berk, Cabin John, MD (US); Miles A. Fawcett, Washington, DC (US); Lisa S. Hartley-Bream, Arlington, VA (US); Eve Simon, Washington, DC (US); Gil D. Ziv, Washington, DC (US); Oksana Kilmova, Laurel, MD (US)

Correspondence Address: Supervisor, Patent Prosecution Services, PIPER MARBURY RUDNICK & WOLFE LLP, 1200 Nineteenth Street, N.W., Washington, DC, 20036-2412, US

(21) Appl. No.: 09/918,825

(22) Filed: Aug. 1, 2001

Related U.S. Application Data
(60) Provisional application No. 60/223,976, filed on Aug. 9, 2000.

(51) Int. Cl. G09G 5/12

(52) U.S. Cl. 707/500.1

(57) ABSTRACT

An apparatus, system and method for creating a personalized multimedia content using interactive multimedia applications. The method of the invention creates a personalized multimedia content by conducting an interactive online interview of a user, compiling data based on responses of the user, analyzing the compiled data to create the personalized multimedia content, and distributing the personalized multimedia content to a host or sponsor to facilitate marketing efforts. The marketing efforts include one-to-one marketing efforts, inventory controls, and resell of the personalized multimedia content with permission from the user. The personalized multimedia content can be created in real time. The personalized multimedia content can be customized to a specific market and commercial needs of the host or sponsor. The personalized multimedia content can increase online traffic, encourage repeat to the host or sponsor's site, and generate new revenue streams. The personalized multimedia content may be stored in a personal file or linked to related contents or events over the Internet via a Web site.

This application claims priority from U.S. Provisional Application Serial No. 60/223,976 filed Aug. 9, 2000. The entirety of that provisional application is incorporated herein by reference.

### BACKGROUND OF THE INVENTION

1. Field of the Invention

This invention generally relates to computer-assisted interactive multimedia contents and, more specifically, to an apparatus, system and method for creating real-time personalized multimedia contents using interactive multimedia applications. The personalized multimedia contents may be stored in personal files or linked to related contents or events over the Internet via a Web site.

2. Description of Related Art

Interactive multimedia application via the Web has become increasingly popular and is one of the fastest growing uses of the Internet. The Web generally operates on a client/server model; that is, a user (e.g., a client) runs a piece of software on his/her personal computer to use the resources of a host (e.g., server computer). The host allows many different users to access its resources at the same time and need not be dedicated to providing resources to a single user. In this model, the client software (e.g., a browser) runs on the user's computer, which contacts a Web server and requests information or resources. The Web server locates and then sends the information (e.g., text, audio, video, etc.) or resources to the browser, which then interprets the received information or resources and provides the results to the user's computer.

With interactive multimedia application, communication between a user and an application program (e.g., a browser) is symmetric. Consequently, large amount of multimedia data (text, audio, video, etc.) may be sent and received between the user and the application program. As a result, there are numerous potential uses of interactive multimedia application via the Web.

### SUMMARY OF THE INVENTION

Exemplary embodiments of the invention include apparatuses, systems and methods for creating real-time personalized multimedia contents using interactive multimedia applications. The personalized multimedia contents may be stored in personal files or linked to related contents or events over the Internet via a Web site. Features of the invention include developing personalized merchandising opportunities, facilitating increased user interaction, and creating viral communication and enhanced traffic.

The personalized marketing tool includes a front end user interface, a back end database, and an end product, which is a personalized multimedia content.

The front end user interface allows a user, through multimedia prompts, to make various selections that are either prepackaged (multiple choice), or the user can make free expressions. These selections, for example, re-tell an event, create a new story, or merge a user's opinion with a product or service.

The back end database compiles, analyzes and stores all the answers (data) provided by the user. The compiled data can be reported to the host or sponsor of the tool in real time. The data provided by the user, for example, can be linked to and integrated with a sponsor's customer relationship management (“CRM”) system. The data can be used to facilitate one-to-one marketing efforts, for inventory controls, or to be resold (with the user's permission).

The interactive multimedia applications of the invention allows the user to receive in real time, personalized multimedia content that can include, for example, personal images, video sound files, text and pre-selected graphics. This content is created dynamically and provided to the user via a link to a file that resides on a server of the invention. The user can reach that link through a unique uniform resource locator (“URL”) and share that link with family, friends, etc., who can add content and create a multimedia end product.

The personalized multimedia content is not limited to a user and may be created for different groups of users, organizations, or any foreseeable application.

### BRIEF DESCRIPTION OF THE DRAWINGS

The accompanying drawings, which are incorporated in and constitute a part of the specification, illustrate exemplary embodiments of the invention and, together with the detailed description of the invention, explain various aspects and principles of the invention. In the drawings:

FIG. 1 is an illustration of an exemplary computer network on which a system and method for creating a real-time personalized multimedia content may be implemented in accordance with an exemplary embodiment of the invention;

FIG. 2 is a flowchart illustrating a method for creating a real-time personalized multimedia content according to an exemplary embodiment of the invention;

FIG. 3 is an exemplary “choose your personality” screen according to an exemplary embodiment of the invention; and

FIG. 4 is an exemplary “my ideal soul mate” screen according to an exemplary embodiment of the invention.

### DETAILED DESCRIPTION OF THE INVENTION

The following detailed description refers to the accompanying drawings that illustrate exemplary embodiments of the invention. Other embodiments are possible and modifications may be made to the exemplary embodiments without departing from the spirit and scope of the invention. Therefore, the following detailed description is not meant to limit the invention. Rather, the scope of the invention is defined by the appended claims.

The invention is directed to an apparatus, system and method for creating a real-time personalized multimedia content using interactive multimedia applications. The personalized multimedia content may be stored in a personal file or broadcasted over the Internet via a Web site.

As described herein, the utility of the invention extends beyond traditional interactive multimedia applications by enabling a user to create his/her own personalized multimedia content using interactive multimedia applications including an online interview. The online interview includes, for example, an actual voice moderator, an interviewer, a pre-programmed script, and a multimedia audiovisual moderator.

An example of the invention is it enables a user to celebrate and focus on his/her life experiences, interests, opinions, goals, aspirations, and fantasies. This is because people often like to talk about themselves and share their life events, experiences, thoughts and perspective with others. Based on this theme, the interactive multimedia applications of the invention capture the human spirit and create a personalized multimedia content of the user. The personalized multimedia content begins with a brief online interview of thought provoking and engaging questions. This interview prompts memory and inspires creativity that allows the user to tell his/her story in an engaging way. The invention provides the user with the tools to add photos, sound and video, and then to share that story with his/her family and friends, who can add their own thoughts and perspectives.

The personalized multimedia content may be distributed to a broad network of affiliates and partners in key demographic markets. The look and feel of the personalized multimedia content can be customized to a specific market and commercial needs of the sponsoring partners. For the partners, the personalized multimedia content builds traffic, encourages repeat visits to sponsors' sites, and generates new revenue streams.

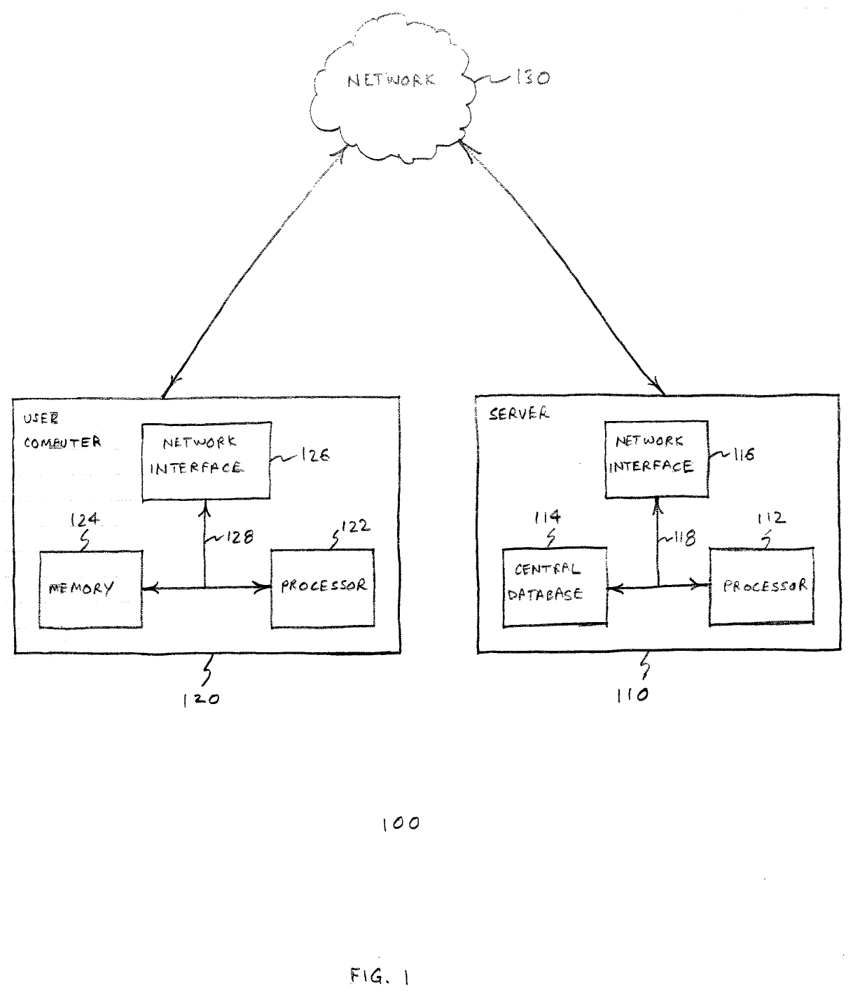

FIG. 1 is a diagram illustrating one exemplary computer network on which a system and method for creating a real-time personalized multimedia content may be implemented. As shown in FIG. 1, a computer network 100 may include a server 110, a user computer 120, and a network 130, which may be or include a publicly accessible network, e.g, the Internet. The server 110, which may be a single server or multiple server (a server farm, etc.), typically includes a processor 112 operatively coupled to a central database 114 and a network interface 116 via a communication/control bus 118. The user computer 120 typically includes a processor 122 operatively coupled to a computer memory 124 and a network interface 126 via a communication/control bus 128. Processor 122 executes program instructions stored in computer memory 124, such as a Web browser program.

User computer 120, by virtue of its connection to network 130, may access and retrieve information stored at other computers coupled to network 130. Server 110 may be a Web server, which is designed to accept information requests, e.g., via Web pages, from user computer 120 and to transmit requested information or resources back to user computer 120. In other words, network 130 may provide access to Web sites that are supported by server 110.

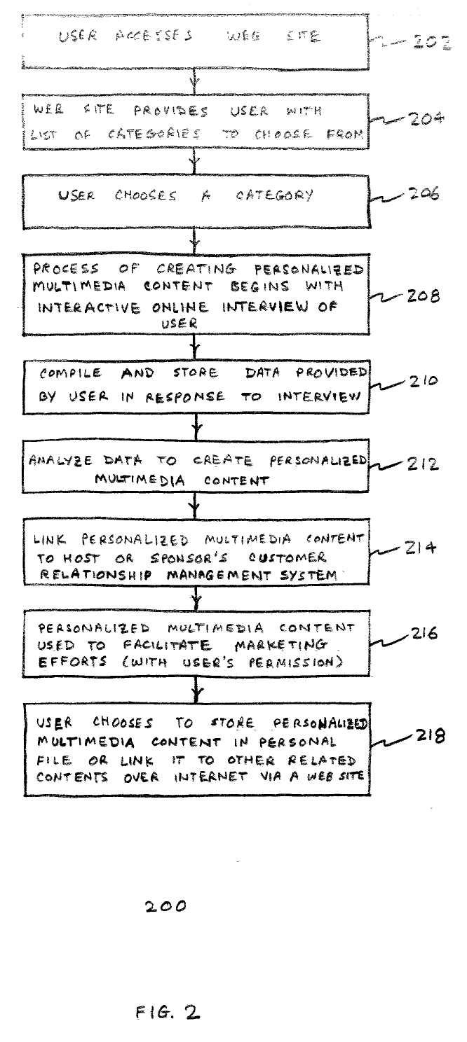

FIG. 2 is a flowchart 200 illustrating the operation of one exemplary method for creating a real-time personalized multimedia content according to an exemplary embodiment of the invention. To begin, a user accesses a Web site supported by a server of the invention at 202 to create a real-time personalized multimedia content. The Web site provides the user with a list of categories to choose from at 204. The list of categories includes, for example, how the user would describe his/her personality, how the user would describe his/her family, how the user would describe his/her soul mate, etc. At 206, the user chooses one of the categories by clicking on the corresponding button on the computer screen, or speaking into the user computer.

Based on the user's chosen category (subject), the method of the invention begins creating a personalized multimedia content by conducting an interactive online interview using a voice moderator, an interviewer, a pre-programmed script, a multimedia audiovisual moderator, or any foreseeable method of interview at 208. At 210, the method of the invention compiles and stores all the data provided by the user in response to the interview at a back end database. The stored data (responses to questions during the interview) is then analyzed to determine the user's interests, opinions, goals, aspirations, fantasies, etc., thereby creating a personalized multimedia content at 212. At 214, the method of the invention links or distributes the personalized multimedia content to a host or sponsor's CRM system. The personalized multimedia content can be used to facilitate one-to-one marketing efforts, for inventory controls, or to be resold (with the user's permission) at 216. The user has an option of storing the personalized multimedia content in a personal file, or linking it to other related contents or events over the Internet via a Web site at 218.

A feature of the invention is it enhances and creates new revenue streams for customers, e.g., developing a stronger one-to-one marketing relationship. In one example, the invention provides a multimedia application for Blockbuster that enables its customers to create personalized multimedia movie reviews (or a personalized content that integrates a customer's own life with the thrill and excitement of the movies, such as a movie trailer). The invention application can be offered at Blockbuster stores from a kiosk or from a Web site. In this example, customers will want to complete the process for a number of reasons such as: it is an animated, voice hosted, and very interactive process; the process allows the customers to be stars in their favorite movies; the process allows the customers to be movie critics; and the process allows customers to create personalized multimedia contents in real time. The reviews by customers, for instance, can be shared with friends so as to create viral marketing. Furthermore, the application of the invention can easily be tied to a promotion such as “review/star in the last movie you rented and enter sweepstakes to win a movie each week for free for a whole year.”

The benefits to Blockbuster are enormous. The invention compiles, stores and reports all the information provided by the customers in the context of building their reviews or personalized movie trailers. Blockbuster will be able to efficiently obtain incredible marketing data from its customers in real time. The stored data creates revenue in at least two direct ways. First, the data can be sold to movie studios and other companies hungry for what consumers are saying and thinking about their movies. The review template, i.e., the questions, prompts, and scenarios provided to the consumers can be designed in such a way as to elicit the most valuable information. Second, the data Blockbuster obtains can be used in one-to-one marketing efforts. For example, with the customer's permission, Blockbuster can use just the titles of the reviewed movies to suggest other related movies to the customer. In one hypothetical, a customer hated the movie “Pearl Harbor,” but his/her review gushed about Ben Afleck. Using this data, Blockbuster could “one-to-one” market Ben Afleck movies to that customer and advise that customer, by e-mail or postcard, of when a new Ben Afleck movie hits the stores.

It should be noted that these are just a few ways that the applications of the invention can enhance existing revenue streams for a business. It is foreseeable that a person of ordinary skill in the relevant art can think of countless other ways to create new revenue streams for a business by applying the applications of the invention.

Yet another feature of the invention is it can tailor the interview through various interactive techniques based on a user's response. For example, an online interview may include a pre-programmed script, with several different variations for individual responses to a specific question. A simple example would be a set of questions asked in an interview that would differ based on the sex of the individual user. Also contained within the scope of this invention is an artificial intelligence-like capability for generating unique multimedia content output.

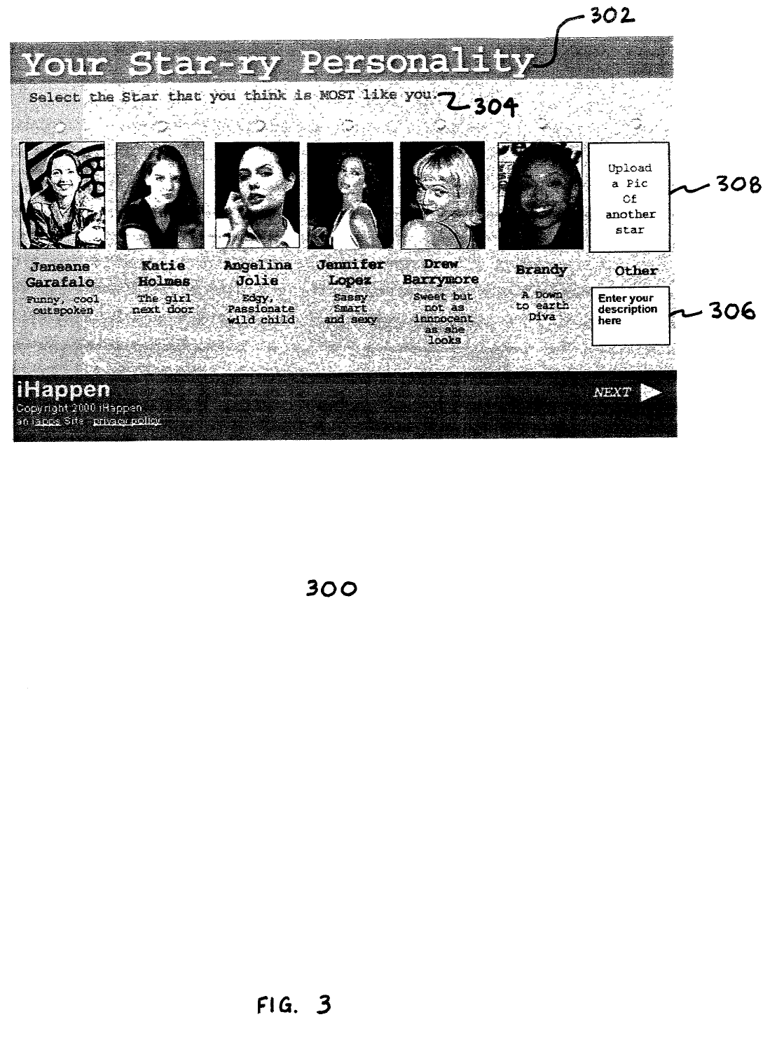

FIG. 3 illustrates an exemplary screen 300 in accordance with an embodiment of the invention where a user chooses “Your Star-ry Personality” 302. In FIG. 3, a user answers questions about her personality in a variety of ways. In particular, answers to questions may involve selecting, for example, a “Star that you think is MOST like you” 304 from a menu of multimedia objects, such as selecting image files from a menu of stars available to play specific roles in the user's life story. Other answers may involve entering text in a box 306 (“Enter your description here”), or uploading video in a box 308 (“Upload a [picture] of another star”). As stated above, the user personality data is then compiled, analyzed, and stored to create the user's personalized multimedia content; the user's personalized multimedia content can be used to facilitate one-to-one marketing efforts and, with the user's permission, the personalized multimedia content can be resold to interested parties.

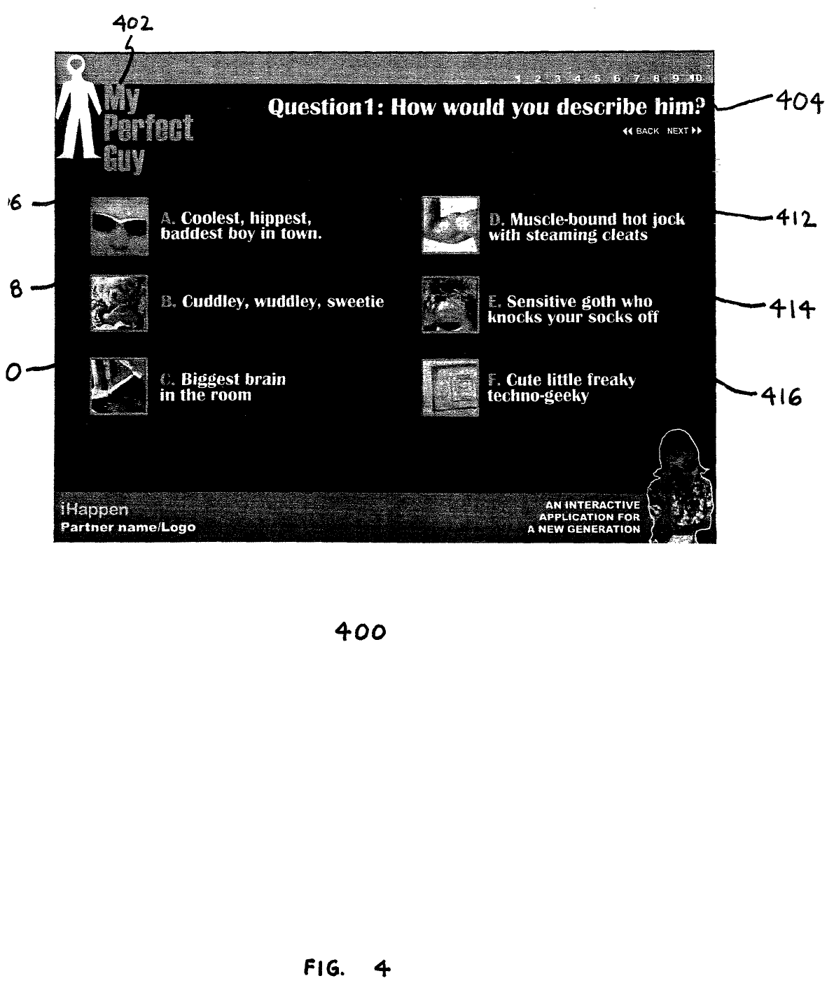

A person of ordinary skill in the relevant art will recognize that many permutations are contemplated by the invention. In particular, the invention provides tools to support other embodiments which may be especially appealing to specific demographic groups. For example, (1) teens may use the invention to produce an interactive magazine cover, (2) athletes may employ the invention to produce an interactive presentation of an athletic contest, such as a game or a race, (3) workgroups may use the invention to produce interactive business plans and other presentations, (4) organizations with recruiting needs, such as schools, businesses, social and political organizations may use the invention to produce interactive recruiting presentations, and (5) the romantically inclined may build a “Wanted Poster” for the date or partner of their dreams as illustrated in FIG. 4.

FIG. 4 illustrates an exemplary screen 400 in accordance with an embodiment of the invention where a user chooses “My Perfect Guy” 402. In FIG. 4, a user answers “Question 1: How would you describe him?” 404 by clicking on a letter corresponding to the description of that person, e.g., click on “A” 406 for the “Coolest, hippest, badest boy in town”, “B” 408 for a “Cuddly, wuddley, sweetie” kind of guy, “C” 410 for the “Biggest brain in town”, “D” 412 for a “Muscle-bound hot jock with steaming cleats”, “E” 414 for a “Sensitive goth who knocks your socks off, and “F” 416 for a “Cute little freaky techno-geeky”.

The above illustrations enhance sponsorship opportunities since users spend more time on each site completing the event or experience. In other words, each screen can be used to promote products and services, and create a range of opportunities for marketing and promotional activities based on the selections and preferences of the user. This results in increased traffic and duration of visits.

Another feature of the invention is a variety of types of user input may be used. Examples include uploading archival information from various sources, such as through licensed access to various libraries (e.g., photographs, famous speeches, maps, statistics, trivia) that users want to add to their personalized contents.

Yet another feature of the invention is input to the invention can be provided by several users, as in the example of a family using the tool to develop a family history or multi-generational life story, or a club, business, or other group developing its interactive output. In such cases, multiple users can provide input, and the output will be affected accordingly.

The invention also contemplates a variety of output from the multimedia development tool, including text, audio, and video, with each containing customized content. In other words, the output from the invention can vary according to the specific environment to which the invention is applied. For instance, the multimedia output of a user's movie-based life story will differ significantly from that developed by an enthusiastic user who wishes to chronicle a recent or hypothetical future chess game. Furthermore, each type of output generated by the creative tool of the invention can include embedded content that is specifically selected consistent with the user's preferences and input. For example, if a user wishes to prepare a movie-themed profile, his/her output may include a multimedia interview and commentary from a director whose specialty is consistent with the theme of the movie, such as Ivan Reitman or Mel Brooks for a comedic theme, or James Cameron for an action theme.

The invention may be further understood by reference to the additional examples of applications of the tools of the invention.

In one example, the invention adds a twist to journal writing and diaries which, of course, have been around for centuries. But new technology and particularly the proliferation of email make it easier than ever to document and share a user's life journey with family and friends and even a larger community, if the user chooses so. In particular, the invention makes the process even more fun and accessible. For instance, an online voice-prompted interview on a daily, weekly, or monthly basis could be provided to allow a user to build a journal, diary or memoir online on a regular basis. This interview facilitates the memory process and makes keeping a journal a whole new multimedia experience. That is, subscribers can add photos, sound files, and archival information from the Internet. The contents of the journal can easily be shared with friends and family; the user also has the option to post the journal online or a bulletin board to facilitate “chat” and “community.” The contents of the journal can also be compiled into a larger story or enhanced by, for instance, topical news stories, facts that relate to the user's experience and even music.

Another example of the application of the invention is a user's “fantasy and adventure.” Everyone has dreams and fantasies and, seizing upon that basic human experience, the invention could build a dynamic and exciting interactive application that can nicely complement the invention's other offerings. In building an interactive fantasy application, e.g., “My Fantasy Vacation,” a user would be prompted through a “voice-prompted” interview on what their fantasy vacation would look, feel and sound like. The tone, as with the other applications, would be fun, engaging and entertaining. Questions in the interview might include: location of the fantasy vacation (e.g., a secluded island in the Pacific, Paris, the South Pole); participants on the vacation (e.g., your spouse, family, mother-in-law, or current Hollywood star); entertainment for the trip (e.g., the user's favorite rock band, golf clubs, books, rock climbing equipment).

At the end of the interview, the invention would provide the user with a multimedia “travel poster” highlighting their responses and a story about their trip. This poster can be printed on just about anything (“My fantasy vacation to . . . ”) and sent to family and friends or posted on a bulletin board to facilitate “chat” and “community.”

Other similar fantasies and dreams include: automobiles (design your “fantasy car”); entertainment (“star in your own movie”); sports (a multimedia fantasy sports team; create a personalized team photo of a user's fantasy line-up with the user as a player or coach); and politics (“my run for the presidency” with the invention application building a multimedia campaign poster and brochure setting forth the user's platform).

In addition to being fun and engaging, the journal also serves as a great platform for promotional activities, marketing programs and targeting sales of products and services based on the stated preferences of the users.

Yet another example of a user's fantasy is “My Fantasy or Perfect Prom Experience.” Here, the online event would ask questions and create scenarios such as: who would be my date; how would my date and I get to the prom; who would I go with; what would be the song of our first dance; what would I wear; what shoes would I choose; what make-up would I use, etc. After the user completes the event, he/she could create a video that would compile all the answers in a video that could be shared with friends and family. The event would be sponsored by various vendors (dress makers, make-up products, hair care products, etc.) and the data compiled would be sent to those vendors to create one-to-one marketing promotions or be used for inventory control. In this example, a vendor would know what it needs to order (e.g., dress style) in advance based on answers to the event questions. Moreover, the vendor could change their home page to feature a dress style that seems most popular at the moment.

The specification pages, including printed internet Web pages attached hereto, are representative examples of several elements of a preferred embodiment of the invention. They should not be construed so as to restrict the subject matter of the invention herein disclosed.

What is claimed is:

1. A method for creating a personalized multimedia content, comprising:
conducting an interactive online interview of a user;
compiling data based on responses of the user to the interview;
analyzing the compiled data to create the personalized multimedia content; and
distributing the personalized multimedia content to at least one of a host and a sponsor to facilitate marketing efforts.

2. The method of claim 1, wherein the marketing efforts include at least one of a one-to-one marketing effort, an inventory control, and a resell of the personalized multimedia content.

3. The method of claim 2, wherein the resell of the personalized multimedia content is done with permission by the user.

4. The method of claim 1, wherein the personalized multimedia content is created in real time.

5. The method of claim 1, further comprising integrating the personalized multimedia content with a customer relationship management (CRM) system of the host or the sponsor.

6. The method of claim 1, wherein the personalized multimedia content is distributed in key demographic markets.

7. The method of claim 1, wherein the personalized multimedia content can be customized to a specific market or commercial needs of the host or the sponsor.

8. The method of claim 1, wherein the personalized multimedia content can increase online traffic, encourage repeat to the host or sponsor's site, and generate new revenue streams.

9. The method of claim 1, further comprising linking the personalized multimedia content with existing related contents or events.

10. The method of claim 1, wherein the creation of the personalized multimedia content stage enhances sponsorship opportunities by at least one of promoting products and services, and creating marketing and promotional activities based on the compiled data.

11. The method of claim 1, wherein creation of the personalized multimedia content is driven by at least one of an event, a product, and a survey.

12. The method of claim 1, wherein the interactive online interview is voice hosted.

13. The method of claim 1, wherein the interactive online interview is conducted by at least one of a voice moderator, an interviewer, a pre-programmed script, and a multimedia audiovisual moderator.

14. The method of claim 13, wherein the pre-programmed script includes different variations based on the user's response to a specific question.

15. The method of claim 1, wherein output of the personalized multimedia content includes at least one of a text output, an audio output, and a video output.

16. The method of claim 1, wherein the personalized multimedia content is stored in a personal file.

17. The method of claim 1, wherein the personalized multimedia content is linked to a Web site.

18. The method of claim 17, wherein the personalized multimedia content can be shared by others including family and friends by accessing the Web site.

19. The method of claim 18, wherein the family or friends can add their own thoughts or perspectives to the personalized multimedia content.

20. The method of claim 1, wherein the interactive online interview involves at least one of entering text, uploading video, uploading audio, uploading graphic content, uploading archival information, and selecting from a menu of multimedia objects.

21. The method of claim 20, wherein the archival information includes at least one of a licensed access to a photograph, a famous speech, a map, and any information that the user may want to add to the personalized multimedia content.

22. A method for creating a business plan among workgroups, comprising:
conducting an interactive online interview of each of the workgroups using a pre-programmed script;
developing a profile for each of the workgroups based on responses by the workgroups to the pre-programmed script; and
creating the business plan based on the profiles of the workgroups.

23. A server operating in a network environment, comprising:
an interface that outputs information to and receives information from a user;
a database, operationally coupled to the interface, for storing computer readable instructions; and
a processor, operationally coupled to the interface and the database, for executing the computer readable instructions to create a personalized multimedia content of the user.

24. A system for creating an interactive personalized multimedia content, comprising:
a computer for a user to request and access information via a network in order to create the personalized multimedia content;
a server for executing computer readable instructions to create the personalized multimedia content; and
the network, operationally coupled to the computer and the server, for providing communication between the computer and the server.

25. The system of claim 24, wherein the personalized multimedia content is created in real time.
